(19) United States
(12) Patent Application Publication
(10) Pub. No.: US 2018/0295195 A1
(43) Pub. Date: Oct. 11, 2018

(54) METHOD AND APPARATUS FOR PERFORMING STORAGE SPACE MANAGEMENT FOR MULTIPLE VIRTUAL MACHINES

(71) Applicant: Synology Incorporated, Taipei (TW)

(72) Inventor: Jie-Wen Wei, Taipei (TW)

(21) Appl. No.: 15/682,526

(22) Filed: Aug. 21, 2017

(30) Foreign Application Priority Data
Apr. 6, 2017 (CN) 201710221716.8

(51) Int. Cl. H04L 29/08; H04L 29/12

(52) U.S. Cl. CPC H04L 67/16; H04L 61/20

(57) ABSTRACT

A method and apparatus for performing storage space management for a plurality of Virtual Machines (VMs) are provided, and the method is applied to a storage system including a plurality of storage servers. The method includes: receiving a request regarding any VM of the plurality of VMs; determining a storage region in the storage system according to the request to store data of the VM into the storage region, wherein the storage region is assigned to the VM; determining another storage region in the storage system according to geolocation classification information of at least one portion of storage servers within the plurality of storage servers, wherein the storage region and the other storage region are positioned in different storage servers within the at least one portion of storage servers, respectively; and storing a replication version of the data into the other storage region.

### BACKGROUND OF THE INVENTION

### 1. Field of the Invention

The present invention relates to data storage, more particularly, to a method for performing storage space management for a plurality of virtual machines (VMs), and an associated apparatus.

### 2. Description of the Related Art

The complexity of implementing the communications and the corresponding operation management between the server and the storage device has increased as the application of the virtualization technology has increased in popularity.

Some methods are proposed in the related art to perform data protection under the virtualization architecture. These methods, however, cannot assure that the whole system is able to operate smoothly in any of various situations and maintain the data protection mechanism in the meantime. For example, when something happens (e.g. a regional disaster such as flood and fire), the system data (e.g. the virtual machine data) might be inaccessible, and it might still be inaccessible even with replication stored additionally which is not corrupted. To fix the system, an extra process such as a manual operation performed by a custodian (e.g. a system manager) is needed. Therefore, a novel method and an associated architecture for enhancing the performance of the storage system are desired.

### SUMMARY OF THE INVENTION

One of the objectives of the present invention is to provide a method for performing storage space management for a plurality of virtual machines, and an associated apparatus, in order to solve the abovementioned problem.

Another objective of the present invention is to provide a method for performing storage space management for a plurality of virtual machines, and an associated apparatus, in order to make sure the virtual machine service can resume immediately and the data protection level can be maintained when the disaster happens.

At least one embodiment of the present invention provides a method for performing storage space management for a plurality of virtual machines (VMs). The method is applied to a storage system, and the storage system includes a plurality of storage servers. The method includes: receiving a request regarding any VM of the plurality of the VMs; determining a storage region in the storage system according to the request to store data of the VM into the storage region, in which the storage region is assigned to the VM; determining another storage region in the storage system according to geolocation classification information of at least one portion of storage servers within the plurality of storage servers, in which the storage region and the other storage region are positioned in different storage servers within the at least one portion of storage servers, respectively; and storing a replication version of the data into the other storage region.

At least one embodiment of the present invention also provides an associated apparatus for performing storage space management for a plurality of VMs. The apparatus can be applied to a storage system, and the storage system includes a plurality of storage servers. The apparatus includes a main storage server, in which the main storage server is one of the plurality of storage servers, and is arranged to manage the storage system. For example, the main storage server may be arranged to perform the following operations: receiving a request regarding any VM of the plurality of VMs; determining a storage region in the storage system according to the request to store data of the VM into the storage region, in which the storage region is assigned to the VM; determining another storage region in the storage system according to geolocation classification information of at least one portion of storage servers within the plurality of storage servers, in which the storage region and the other storage region are positioned in different storage servers within the at least one portion of storage servers, respectively; and storing a replication version of the data into the other storage region.

One of the advantages of the present invention is, in comparison with the related art, the method and the apparatus disclosed by the present invention can enhance the stability of the storage system. In addition, the method and the apparatus disclosed by the present invention make sure the virtual machine service can resume immediately and the data protection level can be maintained when the disaster happens, and the custodian (e.g. the system manager) is not required to perform the manual operation during the resuming process of the storage system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a storage system according to an embodiment of the present invention.

FIG. 2 illustrates a geolocation classification information table of the main storage server shown in FIG. 1 according to an embodiment of the present invention.

FIG. 3 is a flowchart illustrating a method for performing storage space management for a plurality of virtual machines according to an embodiment of the present invention.

FIG. 4 illustrates a working flow of a join control scheme of the method shown in FIG. 3 according to an embodiment of the present invention.

FIG. 5 illustrates a working flow of a request processing scheme of the method shown in FIG. 3 according to an embodiment of the present invention.

FIG. 6 illustrates a working flow of a VM disk location control scheme of the method shown in FIG. 3 according to an embodiment of the present invention.

FIG. 7 illustrates a group control scheme of the method shown in FIG. 3 according to an embodiment of the present invention.

FIG. 8 illustrates a replication result of the group control scheme shown in FIG. 7 according to an embodiment of the present invention.

FIG. 9 illustrates a working flow of a dis-join control scheme of the method shown in FIG. 3 according to an embodiment of the present invention.

FIG. 10 illustrates a working flow of a replication count checking scheme of the method shown in FIG. 3 according to an embodiment of the present invention.

### DETAILED DESCRIPTION

One or more embodiments of the present invention provide a method and an associated apparatus for performing storage space management for a plurality of virtual machines (VMs), and both of the method and the apparatus can be applied to a storage system, in which the storage system includes a plurality of storage servers. Examples for the plurality of storage servers may include (but are not limited to): Network Attached Storage (NAS) servers. The aforementioned method for performing storage space management for the plurality of VMs (hereinafter the method) and the aforementioned apparatus for performing storage space management for the plurality of VMs (hereinafter the apparatus) can make sure the storage system is able to operate smoothly and maintain the data protection level in any of various situations. The apparatus may include at least one portion (e.g. a portion or all) of the storage system. More particularly, the apparatus may include a main storage server (MSS) which is one of the plurality of the storage servers and is arranged to manage the storage system. The MSS can control the operation of the storage system according to the method, for example, the internal operations of the storage system and the communications between the storage system and a plurality of external servers (positioned outside the storage system). For example, the MSS is able to provide the storage device related information of the storage system (such as the related information about the plurality of storage servers) to the plurality of external servers. The plurality of external servers can access the storage device related information and send a plurality of storage requests of various levels to the MSS, in which any of the plurality of storage requests may indicate a predetermined data protection level, e.g. any of a plurality of data protection levels. According to the storage device related information and/or the requests from the plurality external servers, the MSS can perform a plurality of managing operations upon one or more other storage servers within the storage system. Any of the aforementioned one or more other storage servers can be referred to as a secondary storage server (SSS). The number N of servers within the aforementioned one or more other servers may be a positive integer, and may vary dynamically. For example, the number N can be an enormous positive integer. Examples of the plurality of managing operations may include (but are not limited to):
(1) join and delete the storage server(s), for example, control the SSS to join or dis-join the storage system;
(2) collect the current processing speed for each SSS, for example, the current input/output operations per second (IOPS);
(3) based on the above information (1) and (2), configure the storage system to be a VM-aware storage system equipped with data protection mechanism according to the required access speed and the required data protection level for the external servers, in which the configuration can be adjusted dynamically to correspond to the latest condition of the storage system; and
(4) return the result to the external servers to inform the external servers of the online information of the destination end.

The user may instruct that a VM should be protected by the data protection mechanism. The MSS may determine a VM disk of the VM, such as the storage location of the VM data of the VM (e.g. a certain storage server within the SSSs), and may determine the storage location(s) of one or more replication versions of the VM data (e.g. one or more other storage servers within the SSSs). In addition, the data protection levels can be divided into at least two dimensions: the data loss amount and the continuous accessibility. When the data loss amount is relatively small, the data protection level is relatively high; for example, the MSS can store every input/output (I/O) data into the one or more replication versions in real time to minimize the data loss. When the data loss amount is relatively large, the data protection level is relatively low; for example, the MSS can store the changed data into the one or more replication versions for every specific time period, in which although the data loss amount is relatively large, however, the performance is relatively better. Regarding the continuous accessibility, the MSS can determine the quantity of the one or more replication versions (i.e. the replication count) according to the importance of the VM, which means, the bigger replication count represents the higher data protection level; for example, when the disaster occurs, some storage servers may corrupt or become offline, however, the MSS can immediately resume the VM service and maintain the data protection level according to the replication version(s) in the storage servers that are available.

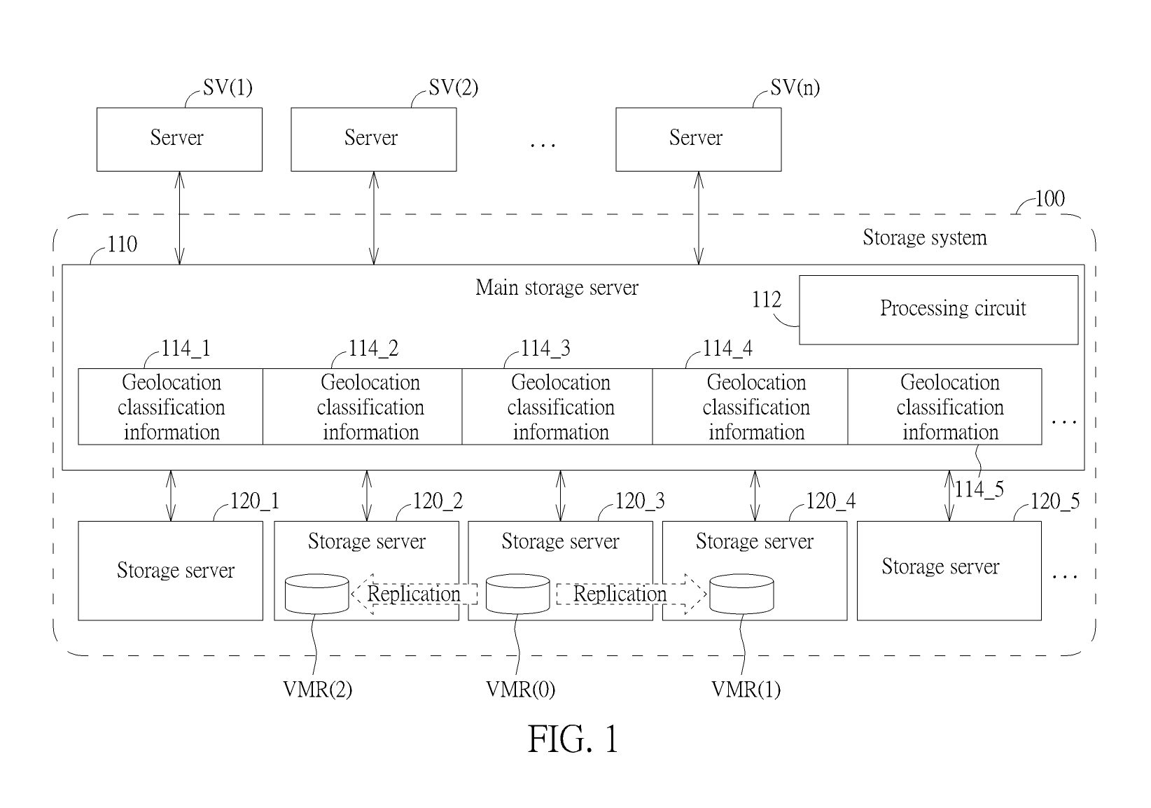

FIG. 1 is a diagram illustrating a storage system 100 according to an embodiment of the present invention. The storage system 100 can be taken as an example of the aforementioned storage system, a MSS 110 can be taken as an example of the aforementioned MSS, storage servers {120_1, 120_2, 120_3, 120_4, 120_5, . . . } can be taken as examples of the aforementioned SSSs, and servers {SV(1), SV(2), . . . , SV(n)} can be taken as examples of the plurality of external servers, where the notation “n” can be any integer greater than 1. Each of the plurality of storage servers, such as the MSS 110 or each of the storage servers {120_1, 120_2, 120_3, 120_4, 120_5, . . . }, may include a processing circuit for controlling the operations of this storage server according to the method and may include one or more storage devices, e.g. hard disk drives (HDDs) and/or solid state drives (SSDs). For example, the processing circuit 112 may include at least one processor and the related circuits thereof (e.g. bus, memory, control chipset, etc.), in which the processing circuit 112 can execute one or more program modules corresponding to the method to perform the storage space management for the plurality of VMs. For another example, the processing circuit 112 may include an Application-Specific Integrated Circuit (ASIC) including one or more sub-circuits corresponding to the method to perform the storage space management for the plurality of VMs. According to some embodiments, any two of the plurality of storage serves can be identical or similar to each other. Based on at least one replacement/rotation or backup mechanism, any of the plurality of storage servers can be the MSS 110. For example, a certain storage server within the plurality of storage serves may originally plays the role of the MSS 110. When this storage server cannot operate normally (for example, due to damage or power failure), another one within the plurality of storage servers can automatically replace this storage server to continuously perform the storage space management according to the method.

According to the embodiment, the plurality of storage servers, such as the MSS 110 and the storage servers {120_1, 120_2, 120_3, 120_4, 120_5, . . . }, can be positioned in different places (e.g. different buildings, regions, countries, continents, etc.) Any two of the plurality of storage servers may have network interfaces, and are able to perform network connection with each other via the network(s) (e.g. the intranet or the Internet) to exchange or transmit information. In addition, under the control of the processing circuit 112, the MSS 110 can store the geolocation classification information {114_1, 114_2, 114_3, 114_4, 114_5, . . . } respectively corresponding to the storage servers {120_1, 120_2, 120_3, 120_4, 120_5, . . . } into the one or more storage devices of the MSS 110, and also can store the geolocation classification information {114_1, 114_2, 114_3, 114_4, 114_5, . . . } into the memory as the cache data to facilitate the storage space management for the plurality of VMs. For example, the processing circuit 112 may utilize a storage region VMR(0) to store the VM data of the VM, and utilize different storage regions respectively, such as storage regions VMR(1), VMR(2), etc., to store a plurality of replication versions of the VM data. The storage region VMR(0) may represent at least one storage region in the one or more storage devices of the storage server 120_3, the storage region VMR(1) can represent at least one storage region in the one or more storage devices of the storage server 120_4, and the storage region VMR(2) may represent at least one storage region in the one or more storage devices of the storage server 120_2. The size of any of the storage regions VMR(0), VMR(1), and VMR(2) may be adjusted when needed, and more particularly, may occupy the available space in the one or more storage devices, for example. According to the embodiment, the storage system 100 can start performing a plurality of replication operations to replicate from the storage region VMR(0) to the storage regions VMR(1), VMR(2), etc., after the processing circuit 122 determines the location of the storage regions VMR(0), VMR(1), VMR(2), etc. For example, the plurality of replication operations can be triggered by the MSS 110 or the SSS(s) (e.g. any of the storage servers {120_1, 120_2, 120_3, 120_4, 120_5, . . . }).

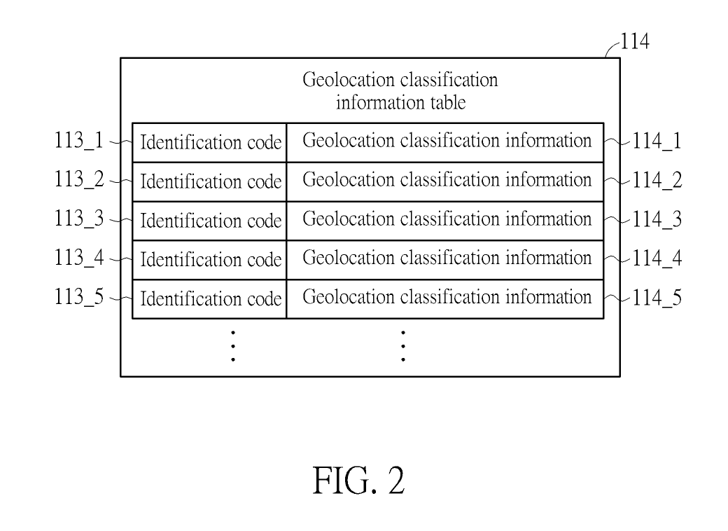

FIG. 2 illustrates is a geolocation classification information table 114 of the MSS 110 shown in FIG. 1 according to an embodiment of the present invention. The geolocation classification information table 114 may include identification codes {113_1, 113_2, 113_3, 113_4, 113_5, . . . } of the storage servers {120_1, 120_2, 120_3, 120_4, 120_5, . . . } and the geolocation classification information {114_1, 114_2, 114_3, 114_4, 114_5, . . . } corresponding to the storage servers {120_1, 120_2, 120_3, 120_4, 120_5, . . . } For example, the MSS 110 and the storage servers {120_1, 120_2, 120_3, 120_4, 120_5, . . . } may be positioned in different places (e.g. different buildings, regions, countries, continents, etc.), and the geolocation classification information {114_1, 114_2, 114_3, 114_4, 114_5, . . . } may indicate the geolocation classification of the storage servers {120_1, 120_2, 120_3, 120_4, 120_5, . . . }. According to the geolocation classification information {114_1, 114_2, 114_3, 114_4, 114_5, . . . }, the processing circuit 112 may determine whether an estimated distance D(SS_{A}, SS_{B}) between any two storage servers SS_{A} and SS_{B} within the storage servers {120_1, 120_2, 120_3, 120_4, 120_5, . . . } is greater or smaller than a reference distance. For example, the reference distance can be an estimated distance D (SS_{A}, SS_{C}) between one of the two storage servers SS_{A} and SS_{B} (e.g. SS_{A}) and another storage server SS_{c} different from the storage servers SS_{A} and SS_{B}. When needed, the processing circuit 112 may determine at least one portion (e.g. a portion of all) of the respective estimated distances {{D(120_1, 120_2), D(120_1, 120_3), D(120_1, 120_4), D(120_1, 120_5), . . . }, {D(120_2, 120_3), D(120_2, 120_4), D(120_2, 120_5), . . . }, {D(120_3, 120_4), D(120_3, 120_5), . . . }, {D(120_4, 120_5), . . . }, . . . } of the storage servers {120_1, 120_2, 120_3, 120_4, 120_5, . . . } to store the VM data and the plurality of replication versions into some storage servers that are relatively far from each other. For example, in response to a request from a certain server SV(n0) of the servers {SV(1), SV(2), . . . , SV(n)}, the processing circuit 112 may assign the storage region VMR(0) as the VM disk of the VM, for storing the VM data of the VM. According to at least one portion (e.g. a portion or all) of the geolocation classification information {114_1, 114_2, 114_3, 114_4, 114_5, . . . }, the processing circuit 112 may determine that the estimated distances {D(120_2, 120_3), D(120_2, 120_4), D(120_3, 120_4) } of the storage servers 120_2, 120_3 and 120_4 are the biggest (or relatively bigger) among the above-mentioned estimated distances. As a result, the processing circuit 112 may assign the storage regions VMR(1) and VMR(2) as the replication storage regions corresponding to the VM disk, for storing the plurality of replication versions, respectively.

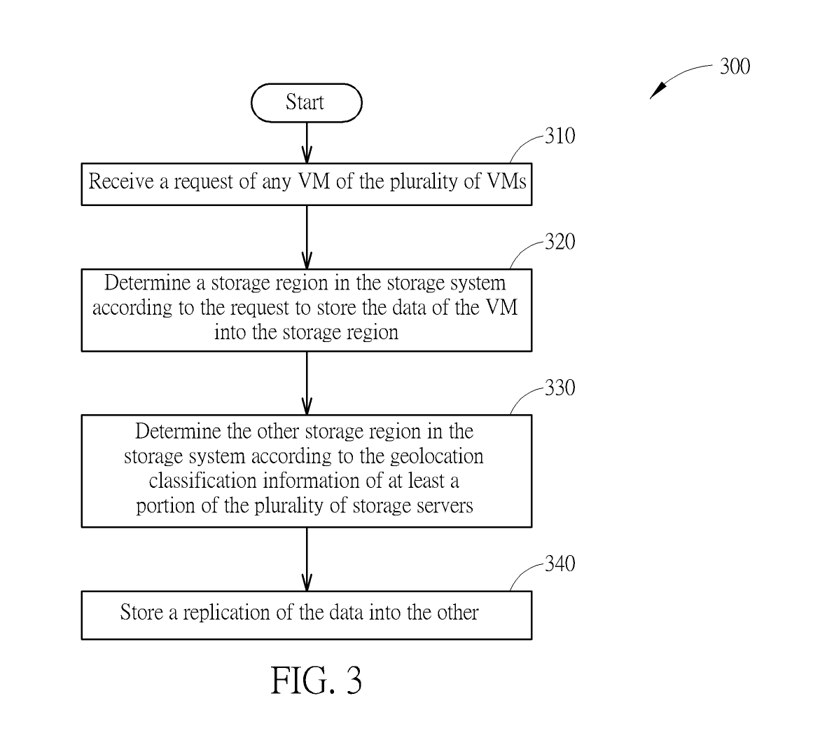

FIG. 3 is a flowchart illustrating a method 300 for performing storage space management for a plurality of virtual machines (VMs) such as that mentioned above according to an embodiment of the present invention. The aforementioned method, such as the storage method 300 shown in FIG. 3, can be applied to the storage system 100 and the MSS 110 shown in FIG. 1, and also to the processing circuit 112 therein. For example, under the control of the processing circuit 112, the MSS 110 can perform the following operations:

In step 310, the MSS 110 may receive a request regarding any VM of the plurality of VMs. The request may be sent from a certain storage server of the servers {SV(1), SV(2), . . . , SV(n)}, such as the server SV(n0). Please note that, with regard to this VM, it is unnecessary that every access operation is performed via the MSS 110. The transmission of the request is usually executed when building this VM in the beginning.

In step 320, the MSS 110 may determine a storage region in the storage system 100 according to the request, e.g. the storage region VMR(0), to store the data of the VM (e.g. the VM data) into the storage region, in which the storage region is assigned to the VM. The data mentioned in step 320 may include: the data required for the operation(s) of the VM, e.g. the data of the operating system of the VM.

In step 330, the MSS 110 may determine another storage region in the storage system, e.g. the storage region VMR(1) or the storage region VMR(2), according to the geolocation classification information of at least one portion of storage servers within the plurality of the storage servers (e.g. a portion or all of the geolocation classification information {114_1, 114_2, 114_3, 114_4, 114_5, . . . }), in which the storage region VMR(0) and the other storage region are positioned in different storage servers within the aforementioned at least one portion of storage servers, respectively.

In step 340, the MSS 110 may control the storage system to store a replication version of the data (e.g. one of the plurality of replication versions) into the other storage region. For example, the MSS 110 may assign the storage regions VMR(1) and VMR(2) as the replication storage regions, respectively, for storing two replication versions, in which the two replication versions can be taken as examples of the replication version mentioned in step 340. The storage server 120_3 may generate a snapshot of the storage region VMR(0), and send snapshot data of the snapshot to the storage servers 120_2 and 120_4, respectively. As a result, the storage servers 120_4 and 120_2 write the snapshot data of the snapshot into the storage regions VMR(1) and VMR(2) respectively as the two replication versions.

According to the embodiment, the geolocation classification information of each storage server of the plurality of storage servers may indicate the classification information of the location of this storage server. The geolocation classification information of this storage server may include geolocation information of a Domain Name System (DNS) server of the storage server. As the plurality of storage servers are usually near a plurality of DNS servers, respectively, the processing circuit 112 may know where (e.g. which country or which geographical region) the plurality of storage servers are positioned, respectively, through those local DNS servers. For example, the processing circuit 112 may obtain DNS server information of the plurality of DNS servers corresponding to the plurality of storage servers, and may determine the geolocation classification such as country, geographical region, etc. of the plurality storage servers according to the DNS server information corresponding to the plurality of storage servers (for example, the top-level domain indicating the geolocation, such as“.br”,“.cn”,“.de”,“.fr”,“.tw”, etc.) to generate the geolocation classification information of all storage servers in the storage system 100, for determining the estimated distance between any two of the plurality of storage servers.

For example, in step 330, the different storage servers may include a first storage server (e.g. the storage server 120_3) and a second storage server (e.g. any of the storage servers 120_2 and 120_4), and the storage region VMR(0) and the other storage region are positioned in the first storage server and the second storage server, respectively. The aforementioned at least one portion of storage servers may include the first storage server, the second storage server and a third storage server (e.g. the storage servers 120_1 and 120_5). The geolocation classification information of the aforementioned at least one portion of storage servers (e.g. the geolocation classification information {114_1, 114_2, 114_3, 114_4, 114_5, . . . }) may indicate the distance between the first storage server and the second storage server is greater than the distance between the first storage server and the third storage server. According to at least one portion (e.g. a portion of all) of the geolocation classification information {114_1, 114_2, 114_3, 114_4, 114_5, . . . }, the MSS 110 (e.g. the processing circuit 112) may determine that the estimated distances {D(120_2, 120_3), D(120_2, 120_4), D(120_3, 120_4) } of the storage servers 120_2, 120_3 and 120_4 are the biggest (or relatively bigger) among the aforementioned estimated distances. As a result, the processing 112 may assign the storage regions VMR(1) and VMR(2) as the replication storage regions corresponding to the VM disk, respectively, for storing the plurality of replication versions, respectively. For brevity, similar descriptions for this embodiment are not repeated in detail here.

According to some embodiments, in the working flow of the method 300 shown in FIG. 3, one or more steps may be added, changed, or deleted. According to some embodiments, the VM data may be changed when the VM starts running. For example, the data mentioned in step 320 may further include: the user data of the user of the VM, and/or program(s) installed in the operating system (of the VM).

The method and the apparatus disclosed by the present invention make sure the VM service can resume immediately and the data protection level can be maintained when the disaster happens, and it is unnecessary for the custodian (e.g. the system manager) to perform the manual operation during the process of resuming the storage system. When the storage device originally assigned as the VM disk (e.g. the storage server 120_3) stops providing service, the MSS 110 may inform at least one external server, such as the server SV(n0), of the location of a certain replication version of the VM data (e.g. the storage server 120_4) to allow the re-establishment of the connection between the server SV(n0) and the storage system 100. While the connection is re-established, the new data from the server SV(n0) might have been written into the storage device where the replication version is positioned. When the re-establishment of the connection is confirmed, the MSS 110 may select a new replication location (e.g. the storage server 120_5) according to the original data protection level such as a predetermined data protection data level (for example, the predetermined data protection data level may indicate that at least two replication versions are required to be maintained all the time), to proceed the data protection.

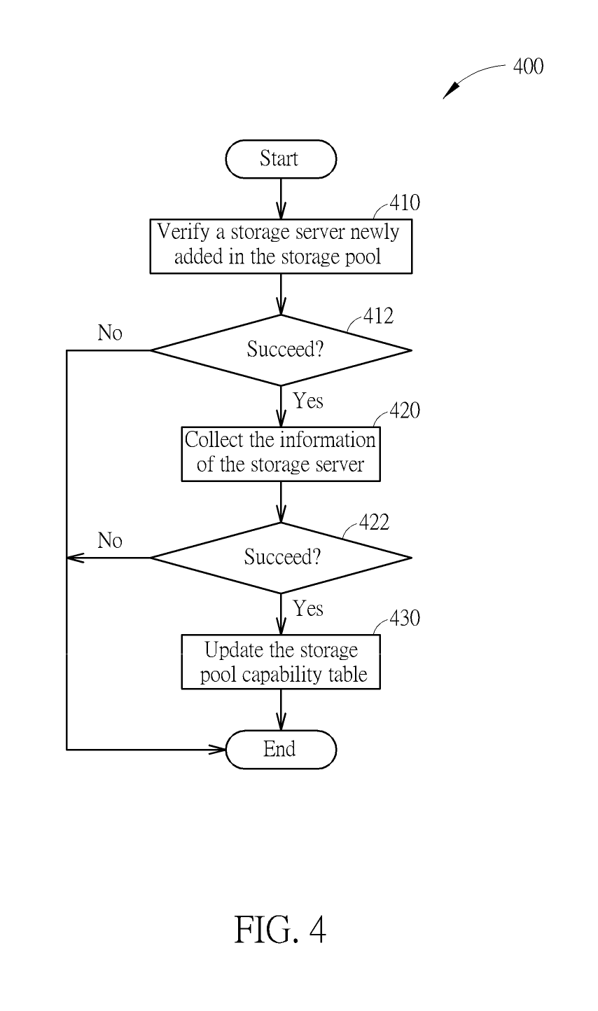

FIG. 4 illustrates a working flow 400 of a join control scheme of the method 300 shown in FIG. 3 according to an embodiment of the present invention. The whole storage space provided by the storage system 100 may be regarded as a storage pool whose size may vary in response to the change of the member of the storage system 100 (e.g. the plurality of storage servers). The MSS 110 (e.g. the processing circuit 112) may generate and update a storage pool capability table to record the latest condition of the current members of the storage system 100, for example, the basic information of each of the plurality of storage servers. The basic information may include: the name of the storage server, the operating ability (e.g. write/read speed) and the device information of each storage device of the storage server.

In step 410, the MSS 110 (e.g. the processing circuit 112) may validate (or verify) a storage server newly added in the storage pool.

In step 412, the MSS 110 (e.g. the processing circuit 112) may check whether the validation (or verification) in step 410 succeeds or not. When the validation (or verification) succeeds, step 420 is entered to take over the communications between the storage server and the server end; otherwise, the working flow 400 comes to the end.

In step 420, the MSS 110 (e.g. the processing circuit 112) may collect the information of the storage server.

In step 422, the MSS 110 (e.g. the processing circuit 112) may check whether the collection in step 420 succeeds or not. When the collection succeeds, step 430 is entered; otherwise, the working flow 400 comes to the end.

In step 430, the MSS 110 (e.g. the processing circuit 112) may update the storage pool capability table.

According to some embodiments, in the working flow 400, one or more steps may be added, changed or deleted. According to some embodiments, the storage pool capability table and the geolocation classification information table 114 maybe integrated into the same table. For clarity purpose, this new table may be referred to as a hybrid storage pool capability table. The hybrid storage pool capability table may include the geolocation classification information table 114 and a plurality of additional fields. For example, the field of the geolocation classification information {114_1, 114_2, 114_3, 114_4, 114_5, . . . } may be located at the left-hand side, the right-hand side of the plurality of additional fields or somewhere in the middle of the plurality of additional fields, and the basic information can be recorded in the plurality of additional fields.

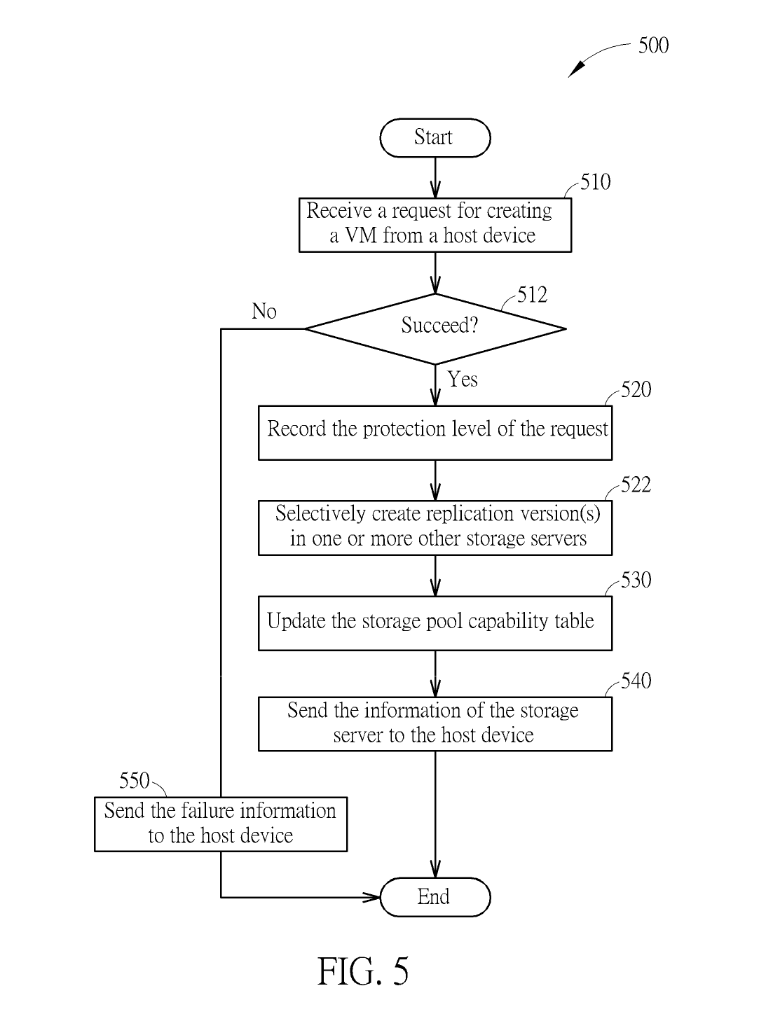

FIG. 5 illustrates a working flow 500 of a request processing scheme of the method 300 shown in FIG. 3 according to an embodiment of the present invention.

In step 510, the MSS 110 (e.g. the processing circuit 112) may receive a request for creating a VM, e.g. the request mentioned in step 310, from a host device (e.g. the server SV(n0)). For example, the request may carry the size of the VM disk of the VM and/or the data protection level of the VM.

In step 512, the MSS 110 (e.g. the processing circuit 112) may check whether enough storage space can be found or not in the storage pool for the VM according to the storage pool capability table. According to the latest content of the storage pool capability table, the processing circuit 112 may select one of the plurality of storage servers as the place for setting up the VM disk, and may check whether the data protection level can be reached (e.g. whether there is suitable storage space or not, for storing the one or more replication versions). When enough storage space is successfully found in the storage pool (which is labeled as “Success” in FIG. 5), step 520 is entered; otherwise, step 550 is entered.

In step 520, the MSS 110 (e.g. the processing circuit 112) may record the protection level of the request, for example, the data protection level.

In step 522, the MSS 110 (e.g. the processing circuit 112) may selectively create replication version(s) in one or more other storage servers. According to this embodiment, the creation can preserve the needed replication storage region (e.g. the storage regions VMR(1) and VMR(2)) first for further usage. For example, when the protection level indicates that the VM needs C_{R} replication version(s), the processing circuit 112 may assign C_{R} storage region(s) (e.g. the storage regions VMR(1) and VMR(2)) as the replication storage regions. For another example, when the protection level indicates that no replication is required, the processing circuit 112 does not have to assign any replication storage region for the VM.

In step 530, the MSS 110 (e.g. the processing circuit 112) may update the storage pool capability table. For example, the storage region VMR(0) cannot be used by any other VM when the processing circuit 112 assigns the storage region VMR(0) as the VM disk. As a result, the available size of the storage server 120_3 decreases. For another example, the storage regions VMR(1) and VMR(2) cannot be used by any other VMS when the processing circuit 112 assigns the storage regions VMR(1) and VMR(2) as the replication storage regions. As a result, the available size of each of the storage servers 120_4 and 120_2 decreases. The processing circuit 112 may update the storage pool capability table correspondingly to indicate the latest values of the available sizes of the plurality of storage servers, respectively.

In step 540, the MSS 110 (e.g. the processing circuit 112) may send the information of the storage server to the host device. For example, the processing circuit 112 may send the online information of the storage server 120_3 to the host device such as the server SV(n0) when the processing circuit 112 assigns the storage region VMR(0) as the VM disk. When the MSS 110 (e.g. the processing circuit 112) confirms that the connection between the server SV(n0) and the storage server 120_3 has been successfully established, the MSS 110 or the storage server 120_3 may trigger the plurality of replication operations to write the replication data to the replication storage region(s).

In step 550, the MSS 110 (e.g. the processing circuit 112) may send the failure information to the host device.

According to some embodiments, in the working flow 500, one or more steps may be added, changed or deleted.

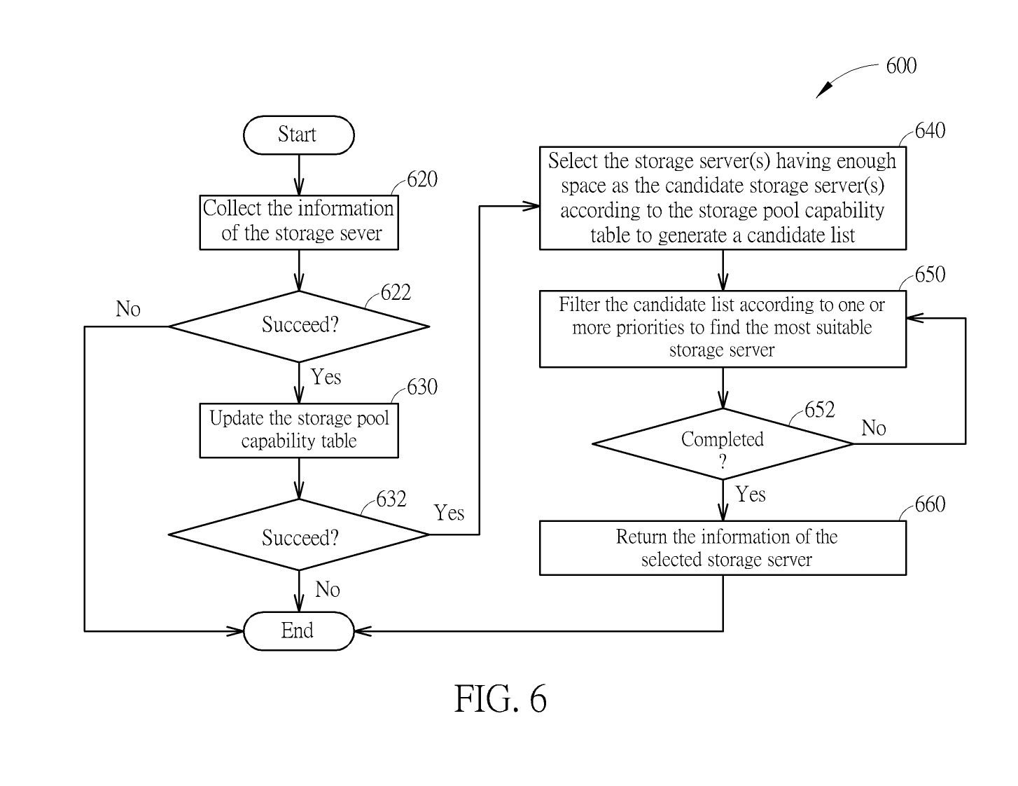

FIG. 6 illustrates a working flow 600 of a VM disk location control scheme of the method 300 shown in FIG. 3 according to an embodiment of the present invention. The working flow 600 can be utilized for finding the location of the VM disk such as the storage server for setting up the VM disk.

In step 620, the MSS 110 (e.g. the processing circuit 110) may collect the information of the plurality of the storage servers, for example, the latest information of the current members in the storage pool.

In step 622, the MSS 110 (e.g. the processing circuit 112) may check whether the collection in step 620 succeeds or not. When the collection succeeds, step 630 is entered; otherwise, the working flow 600 comes to the end.

In step 630, the MSS 110 (e.g. the processing circuit 112) may update the storage pool capability table to include the latest information of the current members in the storage pool.

In step 632, the MSS 110 (e.g. the processing circuit 112) may check whether the update operation in step 630 succeeds. When the update operation succeeds, step 640 is entered; otherwise, the working flow 600 comes to the end.

In step 640, according to the storage pool capability table, the MSS 110 (e.g. the processing circuit 112) may select the storage server(s) having enough space as the candidate storage server(s) from the plurality of storage servers to generate a candidate list, in which the candidate list may include one or more candidate storage servers.

In step 650, according to one or more priorities, the MSS 110 (e.g. the processing circuit 112) may filter the candidate list to find the most suitable storage server. For example, the basic information in the storage pool capability table may include device information of each storage device of each of the plurality of storage servers, in which the device information may include: the storage device type (e.g. HDD or SSD), the total size, the free (available) size, the storage volume number, IOPS, etc. The one or more priorities may be predetermined (or determined in advance) by the user. For example, the priorities, starting from the highest to the lowest priority, may be: the storage device type, IOPS and storage volume number (e.g. the number for complete storage volume(s)). Based on the one or more priorities, the processing circuit 112 can filter the candidate list according to the order from the highest to the lowest priority to select the most suitable candidate storage server.

In step 652, the MSS 110 (e.g. the processing circuit 112) may check whether the filtering operation(s) in step 650 are completed. For example, the one or more priorities may include three priorities, and the cycle formed with steps 650 and 652 may be executed three times correspondingly. In the first cycle, the processing circuit 112 may filter the candidate list according to the storage device type (e.g. HDD or SSD) to generate a first filter result, in which the candidate storage server(s) including SSD may stay and be included in the first filter result while the candidate server(s) without SSD may be excluded; in the second cycle, the processing circuit 112 may filter (e.g. arrange the order of) the first filter result according to IOPS to generate a second filter result, in which the candidate storage server(s) with higher IOPS may stay in the front while the candidate storage server(s) with lower IOPS may stay in the back; In the third cycle, the processing may filter the second filter result according to the storage volume number to generate a third filter result, in which the candidate server(s) with higher storage volume number may stay in the front while the candidate server(s) with lower storage volume number may stay in the back. As a result, the first candidate storage server in the third filter result (e.g. the candidate storage server in the beginning of the filtered list) may be the selected storage server. When filtering operation of each of the one or more priorities is done, step 660 is entered; otherwise, step 650 is entered to continue performing the filtering operation(s).

In step 660, the MSS 110 (e.g. the processing circuit 112) may return the information of the selected storage server. For example, the selected storage server may be the storage server 120_3. In this situation, the processing circuit 112 may assign a storage region (e.g. a storage region in a SSD) in the storage server 120_3 as the VM disk. The processing circuit 112 may control the MSS 110 to send a request to the storage server 120_3 to set up the VM disk, and may return the information (e.g. the online information of the storage server 120_3, the location of the storage region VMR(0)) to the server SV(n0).

According to some embodiments, in the working flow 600, one or more steps may be added, changed or deleted.

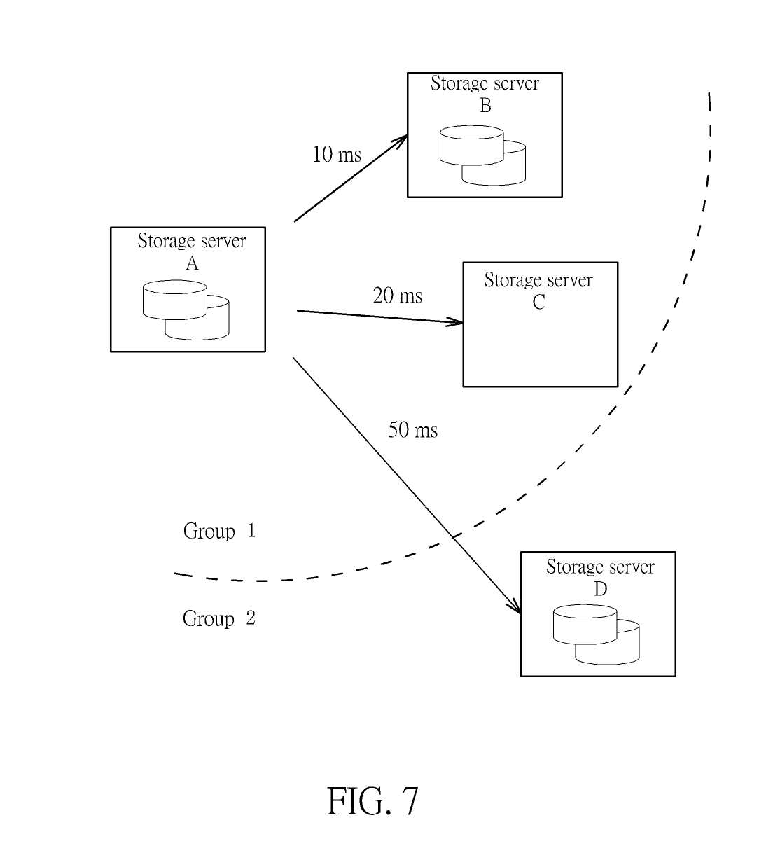

FIG. 7 illustrates a group control scheme of the method 300 shown in FIG. 3 according to an embodiment of the present invention. Assume that the storage servers A, B, C, and D represent the storage servers 120_3, 120_4, 120_5 and 120_2 respectively. Based on the geolocation classification information {114_2, 114_3, 114_4, 114_5}, the MSS 110 (e.g. the processing circuit 112) may divide the storage servers A, B, C and D into group 1 and group 2. With regard to the geolocation, the storage server D is relatively far from the storage server A, while the storage servers B and C are relatively close to the storage server A. For example, the transmission time between the storage servers A and B, that between the storage servers A and C, and that between the storage servers A and D are 10 ms (millisecond), 20 ms, and 50 ms, respectively. The MSS 110 (e.g. the processing circuit) may store the plurality of replication versions into different groups such as the group 1 and the group 2. The probability is low for all different groups being affected when the disaster happens. Therefore, the method and the apparatus disclosed by the present invention can make sure the VM service can resume immediately and the data protection level can be maintained.

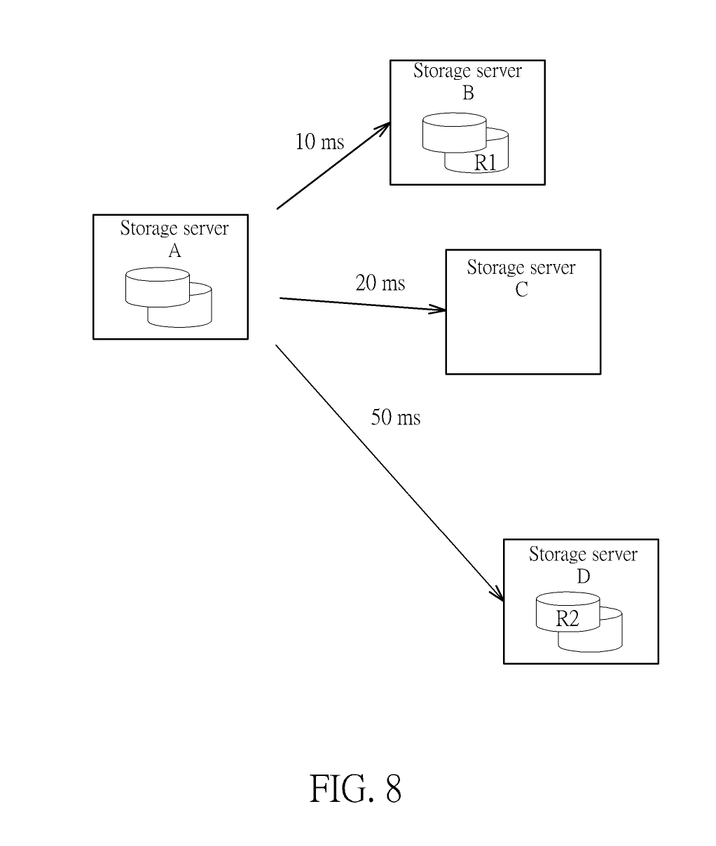

FIG. 8 illustrates a replication result of the group control scheme shown in FIG. 7 according to an embodiment of the present invention. For example, the storage regions R1 and R2 may represent the storage regions VMR(1) and VMR(2) respectively. For brevity, similar descriptions for this embodiment are not repeated in detail here.

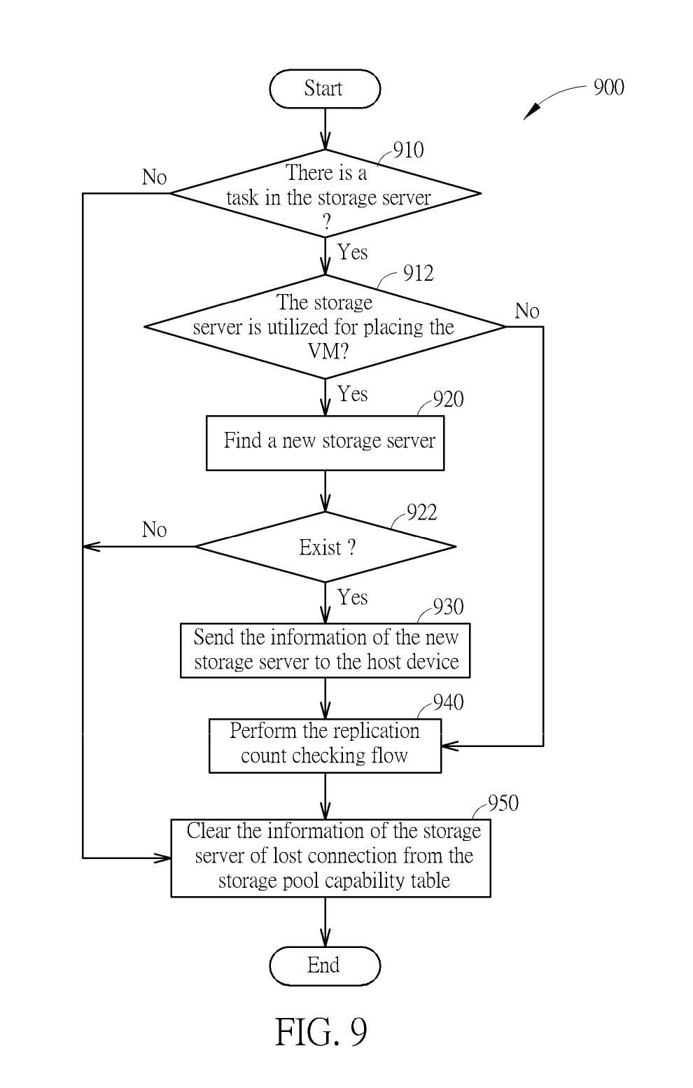

FIG. 9 illustrates a working flow 900 of a dis-join control scheme of the method 300 shown in FIG. 3 according to an embodiment of the present invention. The MSS 110 (e.g. the processing circuit 112) may perform the related control of dis-join when a certain storage server loses connection.

In step 910, the MSS 110 (e.g. the processing circuit 112) may check whether there still is a task in the storage server or not. For example, in a situation where a certain storage region in the storage server has been assigned as the VM disk or a replication storage region, the processing circuit 112 may determine that there is a task in the storage server. When there is a task in the storage server, step 912 is entered; otherwise, step 950 is entered.

In step 912, the MSS 110 (e.g. the processing circuit 112) may check whether the storage server is utilized for placing the VM or not. When the storage server is utilized for placing the VM (e.g. the VM is placed in the storage server), step 920 is entered; otherwise, step 940 is entered.

In step 920, the MSS 110 (e.g. the processing circuit 112) may find a new storage server to try to expand the capability (more particularly, the total storage space) of the storage pool.

In step 922, the MSS 110 (e.g. the processing circuit 112) may check whether the new storage server exists or not. When the new storage server exists, step 930 is entered; otherwise, step 950 is entered.

In step 930, the MSS 110 (e.g. the processing circuit 112) may send the information of the new storage server to the host device such as the server SV(n0).

In step 940, the MSS 110 (e.g. the processing circuit 112) may perform the replication count checking flow.

In step 950, the MSS 110 (e.g. the processing circuit 112) may clear the information of the storage server of lost connection (e.g. the connection between this storage server and the MSS 110 is lost) from the storage pool capability table.

According to some embodiments, in the working flow 900, one or more steps may be added, changed or deleted.

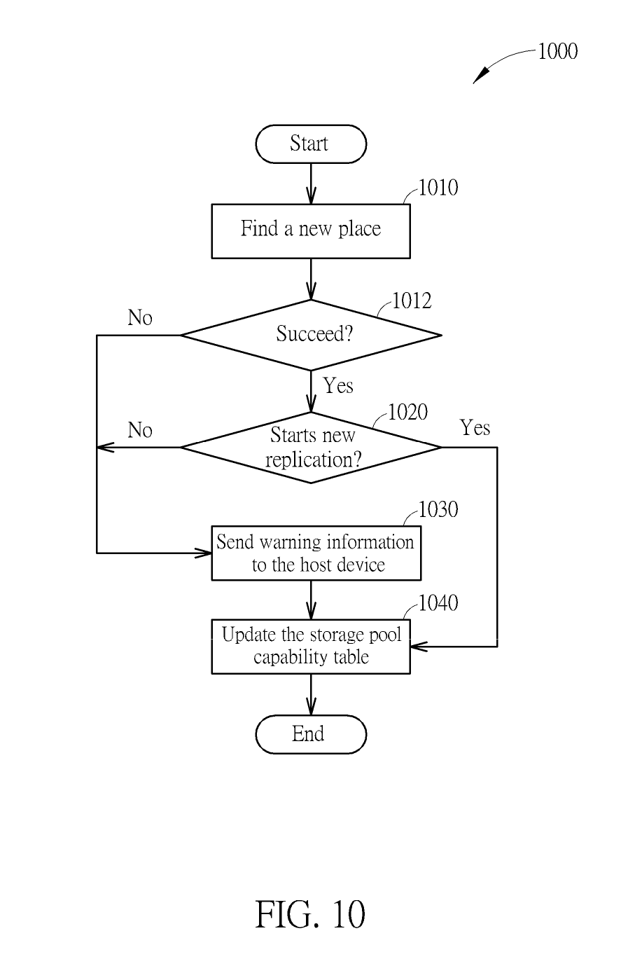

FIG. 10 illustrates a working flow 1000 of a replication count checking scheme of the method 300 shown in FIG. 3 according to an embodiment of the present invention. The working flow 1000 can be taken as an example of the replication count checking flow mentioned in step 940.

In step 1010, the MSS 110 (e.g. the processing circuit 112) may find a new place such as a new storage region. As the storage server of the embodiment shown in FIG. 9 has lost connection (e.g. the connection between this storage server and the MSS 110 is lost), any storage region in the storage server are lost too. No matter whether the lost storage region has been assigned as the VM disk or a replication storage region, the processing circuit 112 may try to replace the lost storage regions with the new storage region to maintain the replication count (e.g. the number C_{R} indicated by the protection level mentioned in step 520).

In step 1012, the MSS 110 (e.g. the processing circuit 112) may check whether the finding operation in step 1010 succeeds or not. When the finding operation succeeds, step 1020 is entered; otherwise, step 1030 is entered.

In step 1020, the MSS 110 (e.g. the processing circuit 112) may check whether new replication starts or not. For example, the processing 112 may assign the new storage region to try to replace the lost storage region with the new storage region, and try to trigger the associated SSS to start the new replication. When it is detected that the new replication has started, step 1040 is entered; otherwise, step 1030 is entered.

In step 1030, the MSS 110 (e.g. the processing circuit 112) may send warning information to the host device such as the server SV(n0).

In step 1040, the MSS 110 (e.g. the processing circuit 112) may update the storage pool capability table.

According to some embodiments, in the working flow 1000, one or more steps may be added, changed or deleted.

According to some embodiments, the locations of the storage regions VMR(0), VMR(1) and VMR(2) shown in FIG. 1 may vary. For example, the processing circuit 112 may assign a storage region within the one or more storage devices of the MSS 110 as the VM disk, for storing the VM data of the VM. In this situation, the storage region VMR(0) may be positioned in the MSS 110. For another example, the processing circuit 112 may assign a storage region within the one or more storage devices of the MSS 110 as one of the plurality of replication storage regions, for storing one of the plurality of replication versions. In this situation, the storage regions VMR(1) or VMR(2) may be positioned in the MSS 110. In addition, besides the geolocation classification information {114_1, 114_2, 114_3, 114_4, 114_5, . . . }, the processing circuit 112 may store the geolocation classification information of the MSS 110 into the one or more storage device of the MSS 110, and more particularly, may store the geolocation classification information of the MSS 110 into the geolocation classification information table 114. For brevity, similar descriptions for these embodiments are not repeated in detail here.

According to some embodiments, in step 330, the different storage servers may include a first storage server (e.g. the storage server 120_3) and a second storage server (e.g. one of the storage servers 120_2 and 120_4), and the storage region VMR(0) is positioned in the first storage server. The abovementioned at least one portion of storage servers may include the first storage server, the second storage serve and a third storage server (e.g. the storage servers 120_1 and 120_5). The MSS 110 (e.g. the processing circuit 112) may compare the geolocation classification information of the first storage server, the second storage server, and the third storage server to generate a comparison result, wherein the comparison result indicates that the distance between the first storage server and the second storage server is greater than the distance between the first storage server and the third storage server. The MSS 110 (e.g. the processing circuit 112) may select the other storage region in the second storage server (e.g. any of the storage regions VMR(1) and VMR(2)) according to the comparison result, rather than selecting any storage region in the third storage server, for storing the replication version of the data in step 320. For brevity, similar descriptions for these embodiments are not repeated in detail here.

The implementation of generating the geolocation classification information may vary. According to some embodiments, when a storage server in the plurality of storage servers joins the storage system 100, the MSS 110 may communicate with a geolocation information server according to a predetermined programming interface such as a geolocation application programming interface (API) to obtain the geolocation information from the geolocation information server. For example, this storage server can be a certain storage server 120_x of the storage servers {120_1, 120_2, 120_3 120_4, 120_5, . . . }, and the geolocation information can be the geolocation information of the DNS server of the storage server 120_x. In addition, the MSS 110 may automatically determine the geolocation classification information of the storage server 120_x according to the geolocation information. Similarly, when needed, the MSS 110 may communicate with the geolocation information server (or another geolocation information server) according to the predetermined programming interface to obtain the geolocation information of the DNS server of the MSS 110 from the geolocation information server (or the other geolocation server), and automatically determine the geolocation classification information of the MSS 110 according to the geolocation information. According to some embodiments, the geolocation classification information of a storage server of the plurality of storage servers includes preset location information of the storage server. When the storage server joins the storage system 100, the MSS 110 may provide a user interface to allow the user to input the preset location information into the storage system 100 in advance. For example, this storage server can be a certain storage server 120_x of the storage servers {120_1, 120_2, 120_3 120_4, 120_5, . . . }, or the MSS 110. According to some embodiments, when a storage server of the plurality of storage servers joins the storage system 100, the MSS 110 may automatically determine the geolocation classification information of the storage server according to the geolocation information of a DNS server of the storage server. For example, this storage server can be a certain storage server 120_x of the storage servers {120_1, 120_2, 120_3 120_4, 120_5, . . . }, or the MSS 110. According to some embodiments, when a storage server of the plurality of storage servers joins the storage system 100, the MSS 110 may automatically determine the geolocation classification information of the storage server according to region setting information of the storage server, wherein the region setting information indicates that the storage server is positioned in the country or the region corresponding to the region setting information. For example, this storage server can be a certain storage server 120_x of the storage servers {120_1, 120_2, 120_3 120_4, 120_5, . . . }, or the MSS 110. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing storage space management for a plurality of virtual machines (VMs), the method being applied to a storage system comprising a plurality of storage servers, the method comprising:
receiving a request regarding any VM of the plurality of VMs;
determining a storage region in the storage system according to the request to store data of the VM into the storage region, wherein the storage region is assigned to the VM;
determining another storage region in the storage system according to geolocation classification information of at least one portion of storage servers within the plurality of storage servers, wherein the storage region and the other storage region are positioned indifferent storage servers within the at least one portion of storage servers, respectively; and
storing a replication version of the data into the other storage region.

2. The method of claim 1, wherein geolocation classification information of each storage server of the plurality of storage servers indicates classification information of a location of the storage server.

3. The method of claim 2, wherein the geolocation classification information of the storage server comprises geolocation information of a Domain Name System (DNS) server of the storage server.

4. The method of claim 1, wherein geolocation classification information of a storage server of the plurality of storage servers comprises a presset location information of the storage server; and the method further comprises:
when the storage server joins the storage system, providing a user interface to allow a user to input the preset location information into the storage system in advance.

5. The method of claim 1, further comprising:
when a storage server of the plurality of storage servers joins the storage system, automatically determining geolocation classification information of the storage server according to geolocation information of a Domain Name System (DNS) server of the storage server.

6. The method of claim 1, further comprising:
when a storage server of the plurality of storage servers joins the storage system, automatically determining geolocation classification information of the storage server according to region setting information of the storage server, wherein the region setting information indicates that the storage server is positioned in a country or a region corresponding to the region setting information.

7. The method of claim 1, wherein the different storage servers comprise a first storage server and a second storage server, and the storage region and the other storage region are positioned in the first storage server and the second storage server, respectively; the at least one portion of storage servers comprise the first storage server, the second storage server and a third storage server; and the geolocation classification information of the at least one portion of storage servers indicate that a distance between the first storage server and the second storage server is greater than a distance between the first storage server and the third storage server.

8. The method of claim 1, wherein the different storage servers comprise a first storage server and a second storage server, and the storage region is positioned in the first storage server; the at least one portion of storage servers comprise the first storage server, the second storage server and a third storage server; and the step of determining the other storage region in the storage system according to the geolocation classification information of the at least one portion of storage servers within the plurality of storage servers further comprises:
comparing the geolocation classification information of the first storage server, the second storage server and the third storage server to generate a comparison result, wherein the comparison result indicates that a distance between the first storage server and the second storage server is greater than a distance between the first storage server and the third storage server; and
according to the comparison result, selecting the other storage region in the second storage server, rather than selecting any storage region in the third storage server, for storing the replication version of the data.

9. The method of claim 1, further comprising:
when a storage server of the plurality of storage servers joins the storage system, communicating with a geolocation information server according to a predetermined programming interface to obtain geolocation information from the geolocation information server; and
automatically determining geolocation classification information of the storage server according to the geolocation information.

10. The method of claim 9, wherein the geolcoation information represents geolocation information of a Domain Name System (DNS) server of the storage server.

11. An apparatus for performing storage space management for a plurality of Virtual Machines (VMs), the apparatus being applied to a storage system comprising a plurality of storage servers, the apparatus comprising:
a main storage server, wherein the main storage server is one of the plurality of storage servers and arranged to manage the storage system, and the main storage server is arranged to perform the following operations:
receiving a request regarding any VM of the plurality of VMs;
determining a storage region in the storage system according to the request to store data of the VM into the storage region, wherein the storage region is assigned to the VM;
determining another storage region in the storage system according to geolocation classification information of at least one portion of storage servers within the plurality of storage servers, wherein the storage region and the other storage region are positioned in different storage servers within the at least one portion of storage servers, respectively; and
controlling the storage system to store a replication version of the data into the other storage region.

12. The apparatus of claim 11, wherein geolocation classification information of each storage server of the plurality of storage servers indicates classification information of a location of the storage server.

13. The apparatus of claim 12, wherein the geolocation classification information of the storage server comprises geolocation information of a Domain Name System (DNS) server of the storage server.

14. The apparatus of claim 11, wherein geolocation classification information of a storage server of the plurality of storage servers comprises a preset location information of the storage server; and when the storage server joins the storage system, the main storage server provides a user interface to allow a user to input the preset location information into the storage system in advance.

15. The apparatus of claim 11, wherein when a storage server of the plurality of storage servers joins the storage system, the main storage server automatically determines geolocation classification information of the storage server according to geolocation information of a Domain Name System (DNS) server of the storage server.

16. The apparatus of claim 11, wherein when a storage server of the plurality of storage servers joins the storage systems, the main storage server automatically determines geolocation classification information of the storage server according to region setting information of the storage server, wherein the region setting information indicates that the storage server is positioned in a country or a region corresponding to the region setting information.

17. The apparatus of claim 11, wherein the different storage servers comprises a first storage server and a second storage server, and the storage region and the other storage region are positioned in the first storage server and the second storage server, respectively; the at least one portion of storage servers comprise the first storage server, the second storage server and a third storage server; and the geolocation classification information of the at least one portion of storage servers indicate that a distance between the first storage server and the second storage server is greater than a distance between the first storage server and the third storage server.

18. The apparatus of claim 11, wherein the different storage servers comprise a first storage server and a second storage server, and the storage region is positioned in the first storage server; the at least one portion of storage servers comprise the first storage server, the second storage server and a third storage server; the main storage server compares the geolocation classification information of the first storage server, the second storage server and the third storage server to generate a comparison result, wherein the comparison result indicates that a distance between the first storage server and the second storage server is greater than a distance between the first storage server and the third storage server; and according to the comparison result, the main storage server selects the other storage region in the second storage server, rather than selecting any storage region in the third storage server, for storing the replication version of the data.

19. The apparatus of claim 11, wherein when a storage server of the plurality of storage servers joins the storage system, the main storage server communicates with a geolocation information server according to a predetermined programming interface to obtain geolocation information from the geolocation information server; and the main storage server automatically determines geolocation classification information of the storage server according to the geolocation information.

20. The apparatus of claim 19, wherein the geolocation information represents geolocation information of a Domain Name System (DNS) server of the storage server.
